(19) United States
(12) Patent Application Publication
(10) Pub. No.: US 2016/0052536 A1
(43) Pub. Date: Feb. 25, 2016

(54) STEERING SHAFT BEARING UNIT AND METHOD FOR PRODUCING THE SAME

(71) Applicant: THYSSENKRUPP PRESTA AKTIENGESELLSCHAFT, Eschen (LI)

(72) Inventors: Matthias NICOLUSSI, Feldkirch (AT); Hieronymus SCHNITZER, Gamprin (LI); Odisseas GOGOS, Altstätten (CH); Benjamin PLESCHKE, Sax (CH); Hannes KURZ, Feldkirch (AT)

(73) Assignee: THYSSENKRUPP PRESTA AG, Eschen (LI)

(21) Appl. No.: 14/781,908

(22) PCT Filed: Jan. 27, 2014
(86) PCT No.: PCT/EP2014/000206

§ 371 Date: Oct. 1, 2015

(30) Foreign Application Priority Data
Apr. 3, 2013 (DE) 10 2013 103 328.8

(51) Int. Cl. B62D 1/19; F16C 43/02; F16C 35/02

(52) U.S. Cl. CPC B62D 1/19; F16C 35/02; F16C 43/02

(57) ABSTRACT

The invention relates to a method for producing a steering shaft bearing unit for supporting a steering shaft of a motor vehicle fed through the steering shaft bearing unit such that the steering shaft can be rotated about a longitudinal axis, wherein the steering shaft bearing unit has a first jacket part and at least one second jacket part and the second jacket part, guided in at least one slide bearing of the first jacket part, is supported in the first jacket part such that the second jacket part can be moved along the longitudinal axis, wherein the slide bearing has at least two slide bearing parts and during the assembly of the steering shaft bearing unit the second jacket part is inserted between the slide bearing parts in a first step, then the slide bearing parts are pressed against the second jacket part in a relative motion toward each other in a second step, and thereafter the slide bearing parts are fixed in the position in the first jacket part achieved by means of the relative motion in a third step.

The present invention relates to a method for producing a steering shaft bearing unit for the mounting of a steering shaft of a motor vehicle, which steering shaft is led through the steering shaft bearing unit, so as to be rotatable about a longitudinal axis, wherein the steering shaft bearing unit has a first casing part and at least one second casing part, and the second casing part, guided in at least one slide bearing of the first casing part, is mounted in the first casing part so as to be displaceable along the longitudinal axis.

The invention also relates to a steering shaft bearing unit for the rotatable mounting of a steering shaft, which is led through the steering shaft bearing unit, of a motor vehicle, and to a steering column for a motor vehicle having a steering shaft bearing unit of said type.

Steering shaft bearing units for the mounting of a steering shaft of a motor vehicle, which steering shaft is led through the steering shaft bearing unit, so as to be rotatable about a longitudinal axis are known in the prior art. To allow the steering shaft bearing unit to be adjusted for the purpose of adapting the position of the steering wheel to the vehicle driver in a longitudinal direction, that is to say along the longitudinal axis, but also in order to permit a shortening of the steering shaft bearing unit in the event of a vehicle crash, steering shaft bearing units are known which have a first casing part and at least one second casing part, wherein the second casing part, guided in at least one slide bearing of the first casing part, is displaceable along the longitudinal axis of the first casing part.

With regard to the displaceable mounting of the second casing part in the first casing part, the slide bearings responsible for this mounting must meet various requirements. Firstly, for the adaptation of the position of the steering wheel to the individual requirements of the vehicle driver, the force required for displacing the first and second casing parts relative to one another should be as low as possible. On the other hand, the slide bearings should however also realize play-free mounting and thus prevent rattling being caused by the two casing parts. In particular, the slide bearing parts must however also ensure that, in the event of a vehicle crash, it is not possible for jamming to occur, or for other force peaks to act on the steering column, as the two casing parts slide one inside the other.

To meet these requirements, the invention proposes a method for producing a steering shaft bearing unit as per claim 1, and a steering shaft bearing unit as per claim 6, and a steering column as per claim 10.

In the method according to the invention, it is therefore provided that the slide bearing has at least two slide bearing parts and, during the assembly of the steering shaft bearing unit, in a first method step, the second casing part is inserted between the slide bearing parts; subsequently, in a second method step, the slide bearing parts are, in a relative movement toward one another, pressed against the second casing part; and subsequently, in a third method step, the slide bearing parts are fixed in the first casing part in the position attained by way of the relative movement.

By virtue of the slide bearing parts being moved toward one another in a relative movement and said slide bearing parts being pressed against the second casing part in the second method step, it is possible for the desired friction forces between the bearing surfaces of the slide bearing parts and the corresponding bearing surfaces of the second casing part to be set very precisely, such that altogether, a defined displacement force can be provided. By means of the fixing of the slide bearing parts in the first casing part during the third method step, the position attained by way of the relative movement in the second method step is fixed, whereby unchanging or constant friction forces and thus also displacement forces are permanently set. The fixing in the first casing part may be realized by way of welding processes that are known per se, such as laser welding, resistance welding, arc welding, inert gas welding etc. or else by riveting, tumbling, clinching, or screwing with fixing by calking and the like. It is important here that the fixing is permanent and is not releasable or re-adjustable during operation. For completeness, it is pointed out here that one or some of the slide bearing parts may also be fixed in the first casing part already before the third method step. To realize the relative movement of the slide bearing parts toward one another in the second method step, it is possible, though not imperatively necessary, for all of the slide bearing parts to be moved. The movement of only one slide bearing part may also suffice for realizing said relative movement and thus the pressing against the second casing part. Then, the third method step involves all or specifically only the remaining slide bearing parts being fixed in the first casing part, such that at least at the end of the third method step, all slide bearing parts, which interact with one another as a slide bearing for the mounting of the second casing part, are fixed in the first casing part in their position attained by way of the relative movement.

The slide bearing parts may be in the form of shell parts, for example in the form of cylindrical casing sections, or else may to a greater or lesser extent be of annular form, or for example also of strip-shaped form or punctiform, in sections. The slide bearing parts are expediently substantially inherently rigid bodies which are preferably free from spring tongues and the like. Expediently, the slide bearing parts are solid bodies without cavities, which bodies exhibit only a certain amount of material-induced elasticity. Shape-induced elasticity, such as is the case for example with spring tongues and the like, is expediently avoided in the case of the slide bearing parts. The number and form of the slide bearing parts may be selected differently. The same applies to the material used. Here, it is possible in particular for slide bearings, or bearing surfaces of the slide bearings and of the second casing part, to be composed of metal, plastic or ceramic. For a simple, inexpensive embodiment, the slide bearing is expediently a simple plain bearing. In the third method step, the slide bearing parts are preferably fixed to the first casing part so as to be immovable. This may be realized by way of a rigid connection between the slide bearing part and first casing part and/or by virtue of the slide bearing part being formed as a substantially rigid body.

For completeness, it is also pointed out that, in methods according to the invention, yet further method steps for the production of the steering shaft bearing unit may be realized before the first method step and after the third method step. Furthermore, it is also pointed out that the first, second and third method steps need not imperatively directly follow one another. It is possible, if expedient, for other method steps to additionally be realized between the first, second and third method steps.

The longitudinal axis of the steering shaft bearing unit is firstly the axis about which the steering shaft, which is rotatably mounted in the steering shaft bearing unit in the complete steering column, rotates when the steering wheel is rotated. Secondly, the longitudinal axis of the steering shaft bearing unit is also the axis along which the first and second casing parts can be displaced relative to one another.

In the implementation of the method according to the invention, preferred variants provide, in the second method step, regulation by which the desired displacement forces can be set. In this case, a first variant provides that, during the second method step, a displacement force required for displacing the second casing part along the longitudinal axis in the first casing part is determined. In this case, the displacement force is thus used directly as a regulation parameter. Such regulation may however also be performed using substitute parameters. Accordingly, it may be provided that, during the second method step, a distance covered during the relative movement of the slide bearing parts toward one another is determined. It is however equally possible, during the second method step, for a force with which at least one of the slide bearing parts is pressed against the casing part during the relative movement to be determined. In the case of the stated regulation in the second method step, for only the regulation by way of the displacement force or only the regulation by way of one of the stated substitute parameters may be performed. It is however equally possible for more than one of the stated regulation parameters to be used for said regulation. Accordingly, it may for example be provided that, by way of distance or force regulation, that is to say by means of at least one of the stated substitute parameters, a coarse adjustment is performed, and then, using the displacement force as regulation parameter, a fine adjustment of the displacement force is subsequently performed. In all of these variants, it is then subsequently expediently provided that the third method step is performed in the position in which the displacement force and/or the travel and/or the force has or have reached a predefined value or lie or lies in a predefined value range. The ultimately set displacement force required for displacing the casing parts relative to one another along the longitudinal axis expediently lies between 100 newtons and 600 newtons. These values more expediently also apply proceeding from the rest position at the start of the displacement movement.

In preferred variants of steering shaft bearing units according to the invention, it is provided that the first casing part has at least one first section and at least one second section, and one of the slide bearing parts is a constituent part of the first section or is fastened to or at least supported in said first section, and that at least one other of the slide bearing parts is a constituent part of the second section or is fastened to or at least supported on said second section. In the production of such steering shaft bearing units, it is then preferably provided that, in the second method step, the sections of the first casing part are moved toward one another in a relative movement in order to press the slide bearing parts against the second casing part, and in the third method step, the sections are fixed to one another in order to fix the slide bearing parts in the position attained by way of the relative movement. In other words, in these variants, it is thus provided that the slide bearing parts are each arranged on one of the sections of the first casing part in the one of the stated ways, and in the second method step, to realize the relative movement of the slide bearing parts toward one another, said sections of the casing part, together with the slide bearing parts arranged thereon, are moved toward one another and pressed against the second casing part. The fixing of the slide bearing parts in the third method step is then performed by virtue of the sections being fixed to one another in the attained positions.

Even though this is a preferred embodiment of the invention, it is pointed out that the invention also encompasses alternatives to this. It is not imperatively provided that, in the second method step, the slide bearing parts are individually or collectively always only moved together with corresponding sections of the first casing part. It may also be provided that, in the second method step, at least one of the slide bearing parts, preferably in a corresponding guide of the first casing part, moves on its own in the first casing part toward the other slide bearing part, and is pressed against the second casing part, to such an extent that the desired position or displacement force is attained. In these embodiments, it is then possible, in the third method step, for the slide bearing part or slide bearing parts to be fixed in the first casing part directly at the corresponding positions.

A steering shaft bearing unit according to the invention for the mounting of a steering shaft of a motor vehicle, which steering shaft is led through the steering shaft bearing unit, so as to be rotatable about a longitudinal axis has a first casing part and at least one second casing part, and the second casing part, guided in at least one slide bearing of the first casing part, is mounted in the first casing part so as to be displaceable along the longitudinal axis. Here, it is provided according to the invention that the slide bearing has at least two slide bearing parts, and the second casing part is mounted displaceably between the slide bearing parts, and the slide bearing parts are fixed in the first casing part. In the complete steering shaft bearing unit, the slide bearing parts are thus fixed in the first casing part. It is expediently provided here, that is to say in the complete steering column, that the second casing part can be displaced relative to the first casing part by a displacement force, acting along the longitudinal axis, with a magnitude of between 100 newtons and 600 newtons. These displacement forces are expediently also realized at the start of the displacement of the two casing parts relative to one another, that is to say proceeding from the rest position. With displacement forces in this value range, it is firstly ensured that, during the longitudinal adjustment of the steering wheel, a displacement of the casing parts relative to one another is possible with relatively low expenditure of force. Secondly, however, in particular with such displacement forces, play-free guidance of the second casing part in the first casing part is also realized, such that no rattling occurs. Furthermore, however, there is no risk of jamming or other sticking of the two casing parts during a relative displacement in the event of a crash.

The steering column according to the invention can be produced by way of the method according to the invention, such that that which has been stated with regard to the method also applies, where applicable, to the steering column, and vice versa.

As already indicated above, in the case of a steering shaft bearing unit according to the invention, it is expediently provided that the first casing part has at least one first section and at least one second section, and one of the slide bearing parts is a constituent part of the first section or is fastened to or at least supported on said first section, and the at least one other of the slide bearing parts is a constituent part of the second section or is fastened to or at least supported on said second section, wherein the sections are fixed to one another in order to fix the slide bearing parts. Reference is however also made to the alternative ready mentioned above, in which at least one of the slide bearing parts is specifically fastened not to a section of said type but directly in the first casing part.

In preferred embodiments of the steering shaft bearing unit according to the invention, it is provided that the first casing part is formed as a type of guide box, preferably as a sheet-metal bent part. The second casing part is expediently a guide tube. The latter may have a circular cross section or else may have non-circular, for example polygonal, cross sections, as the second casing part is indeed mounted in the first casing part not so as to be rotatable but only so as to be displaceable.

In the embodiment with the two sections which are movable toward one another in the second method step, it is expediently provided that the first section of the first casing part is a sheet-metal part which is at least regionally of trough-shaped form, and the second section of the first casing part is a sheet-metal cover part which is or can be fixed between side walls of the first section.

For the rotatable mounting of the steering shaft in the steering shaft bearing unit, it is expediently provided that at least one of the casing parts, preferably the first casing part, has at least one rotary bearing for the rotatable mounting of the steering shaft. Embodiments of the invention are also conceivable in which only the first casing part or only the second casing part, or else both casing parts, have corresponding rotary bearings for the steering shaft. In the operational position of the fully installed steering column, the first casing part expediently points in the direction of the steering wheel, and the second casing part expediently points in the direction of the steered wheels of the motor vehicle.

A steering column according to the invention for a motor vehicle has a steering shaft bearing unit according to the invention, wherein a steering shaft of the steering column is led through the casing parts and is mounted in the steering shaft bearing unit so as to be rotatable about the longitudinal axis.

Steering columns according to the invention are expediently so-called adjustable steering columns. In the case of these, the steering shaft is adjustable in a vertical direction, that is to say in height, and/or in a longitudinal direction, that is to say along the longitudinal axis, together with the steering shaft bearing unit. In the case of the longitudinal adjustment, it is expediently provided that the casing parts of the steering shaft bearing unit are moved or telescoped relative to one another. Steering columns according to the invention expediently have a support unit. Said support unit is fastened to the body of the motor vehicle and bears the steering shaft bearing unit together with steering shaft. The support unit may be of single-part or multi-part form. Steering columns according to the invention furthermore expediently have an energy absorption unit which serves for dissipating energy in the event of a crash, that is to say in the event of a vehicle collision. Said energy absorption unit may be arranged, or act, between parts of the support unit which are movable relative to one another, or else between the support unit and steering shaft bearing unit.

In preferred embodiments, the support unit may in particular have two side cheeks between which the steering shaft bearing unit, in particular the first casing part thereof, is held. It is self-evidently also possible for the steering shaft bearing unit, or in particular the first casing part, to be held on the support unit in some other way. For the adjustable fastening of the steering shaft bearing unit to the support unit, it is expediently provided that one of the casing parts, preferably the first casing part, has one or more support lugs, which in turn preferably each have a hole or a slot. A clamping bolt of a locking device of the steering column, such as is known per se, can be led through said hole or slot.

In preferred embodiments of steering shaft bearing units or steering columns according to the invention, it is provided that the second casing part is fixed or is fastened to a pivot spindle, which is in particular fixed with respect to the vehicle body. A particularly preferred embodiment of the steering column according to the invention has a steering assistance unit. The second casing part is expediently fastened or fixed to said steering assistance unit. The steering assistance unit may, as is known per se, serve for realizing a step-up and/or step-down ratio of the steer angle, and/or for steering force assistance.

It is self-evidently possible for steering shaft bearing units or steering columns according to the invention to also be implemented without a steering assistance unit of said type.

Further features and details of a preferred embodiment of the invention will be discussed below on the basis of an exemplary embodiment according to the invention, in which:

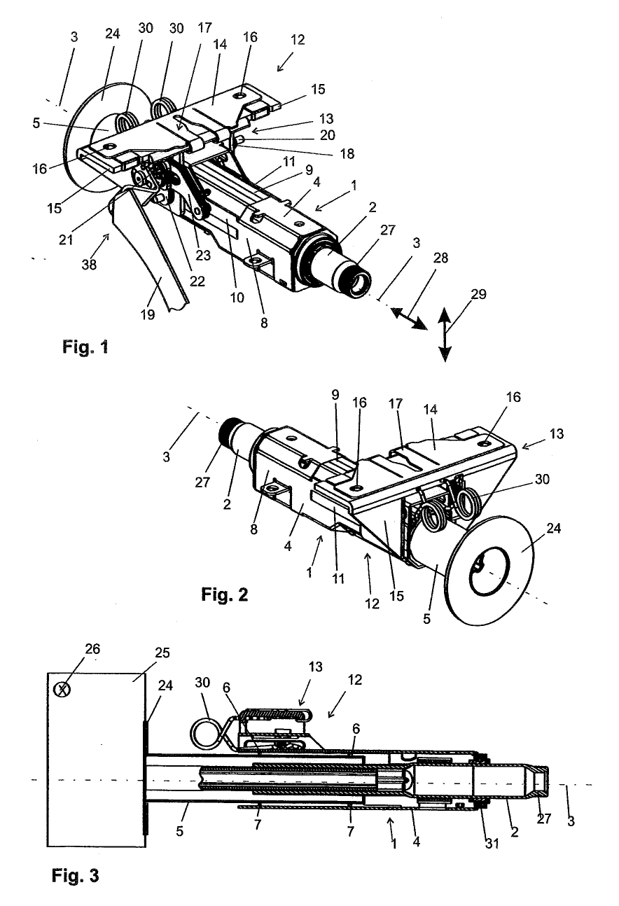

FIGS. 1 and 2 show perspective views of a steering column according to the invention;

FIG. 3 shows a longitudinal section through the steering column as per FIGS. 1 and 2;

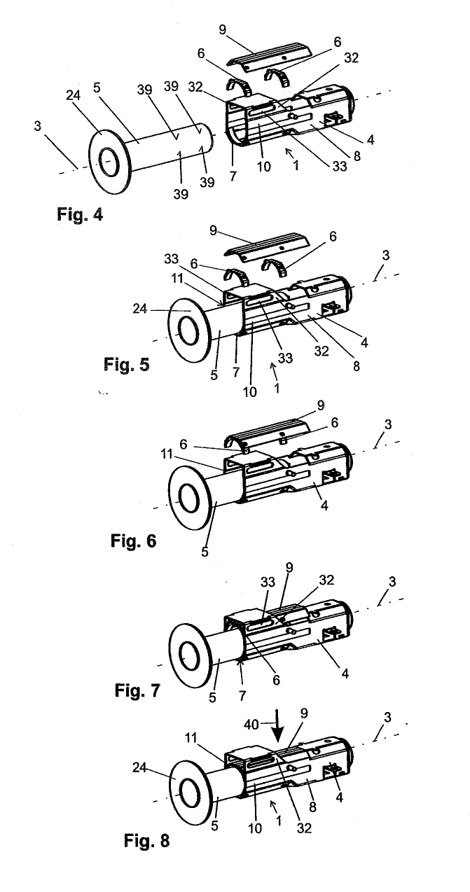

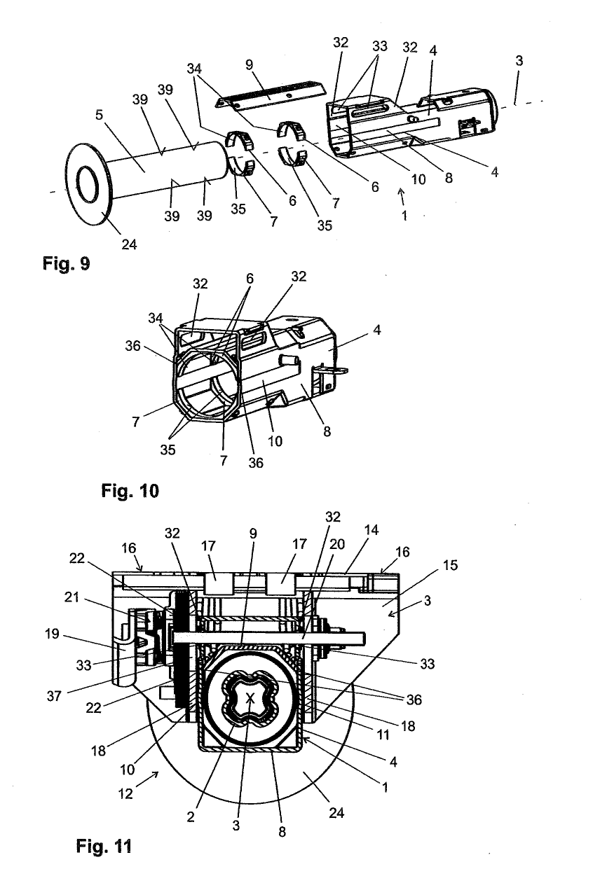

FIGS. 4 to 8 are illustrations showing the method according to the invention for producing the steering shaft bearing unit of a steering column of said type;

FIG. 9 shows the steering shaft bearing unit of the preceding Fig. in an exploded illustration;

FIG. 10 shows the first casing part of said steering shaft bearing unit, and

FIG. 11 is a partially sectional illustration in the form of a vertical section through the steering column, illustrated in FIGS. 1 to 3, in the region of the clamping bolt of the locking device.

FIGS. 1 and 2 are perspective illustrations of the steering column 12 according to the invention. The steering assistance unit 25 provided in this exemplary embodiment is however not illustrated in the figures. Said steering assistance unit is shown in schematic form in FIG. 3. The exemplary embodiment of the steering column 12 according to the invention illustrated here is a steering column which is adjustable both in a longitudinal direction 28 and in a height direction 29. Said steering column has a steering shaft bearing unit 1 according to the invention and a support unit 13. The support unit 13 serves for the fastening of the steering column 12 in the body of the motor vehicle. In the exemplary embodiment shown, the support unit 13 is of multi-part construction. Said support unit has a first support unit part 14 with the fastening lugs 16. By way of the fastening lugs 16, the steering column 12 is fastened to the body of the vehicle. In this exemplary embodiment, a second support unit part 15 has two side cheeks 18, between which the steering shaft bearing unit 1 is arranged. In the event of a crash, the first support unit part 14 and the second support unit part 15 are displaceable relative to one another. Arranged between said support unit parts there is an energy absorption unit 17, which in this exemplary embodiment is in the form of a bent lug. In the event of a crash-induced relative movement between the support unit parts 14 and 15, the energy absorption unit is deformed, as is known per se, with a resulting defined dissipation of energy. This is known per se and does not need to be explained in any more detail. It is merely pointed out that the design of the support unit 13 and of the energy absorption unit 17 may self-evidently also be different.

The steering shaft bearing unit 1 according to the invention has a first casing part 4 and a second casing part 5. The slide bearing realized here, for realizing the displaceability of the first and second casing parts 4 and 5 relative to one another along the longitudinal axis 3, will be discussed in detail further below. In this exemplary embodiment, the first casing part 4 is in the form of a guide box composed of correspondingly deformed sheet-metal parts, and the second casing part 5 is in the form of a casing tube. In the steering shaft bearing unit 1, the steering shaft 2 is mounted so as to be rotatable about the longitudinal axis 3. The steering shaft 2 has the steering wheel connection 27 for the fastening of the steering wheel (not illustrated here). In the exemplary embodiment shown here, the rotatable mounting of the steering shaft 2 is realized firstly by way of the rotary bearing 31 arranged in the first casing part 4, as can be seen particularly clearly in the section in FIG. 3. In the exemplary embodiment shown, the steering shaft 2 is however secondly also mounted in the steering assistance unit 25 (illustrated only schematically here). For completeness, it is pointed out that it is basically self-evidently also possible for the steering shaft 2 to be correspondingly rotatably mounted by means of a rotary bearing in the second casing part 5. In the exemplary embodiment shown here, the steering shaft 2 is likewise of telescopic form, and thus of multipart construction, as can be seen clearly in FIG. 3.

In the exemplary embodiment shown, the steering shaft bearing unit 1 is arranged with its first casing part 4 between the side cheeks 18 of the support unit 13 or of the second support unit part 15. By means of a locking device 38 such as is known per se, the fixing of the steering shaft bearing unit 1 together with steering shaft 3 to the support unit 13 can be eliminated for the purposes of adjustment in the longitudinal direction 28 and/or height direction 29. During normal operation of the motor vehicle, that is to say in particular when the motor vehicle is being driven, the locking device 38 is, by contrast, normally in its closed position, in which it locks the steering shaft bearing unit 1 in its position on the support unit 13.

As is known per se, the locking device 38 realized here has an adjustment lever 19 and a clamping bolt 20 and also a cam-cam follower arrangement 21. Furthermore, said locking device also comprises the plate packs 22 and 23. For the adjustment of the locking device 38 between its open position, in which a height adjustment is possible in the longitudinal and/or height directions 28, 29, and its closed position, in which the steering shaft bearing unit 1 is locked in its position relative to the support unit 13, the adjustment lever 19 is pivotable about a longitudinal axis of the clamping bolt 20. As is known per se, the cam-cam follower arrangement 21 serves to realize a stroke in the longitudinal direction of the clamping bolt 20 during said adjustment movement of the adjustment lever. Said stroke adjusts the locking device 38 between its open position and its closed position, wherein, in the closed position, the side cheeks 18 are pressed against the steering shaft bearing unit 1 with such force that the latter is locked in its position, and in the open position of the locking device, said frictional engagement is eliminated to such an extent that an adjustment of the steering shaft bearing unit 1 is possible in the directions 28 and/or 29. To increase the clamping forces in the closed position of the locking device 38, the exemplary embodiment shown here has, as is known per se, the two plate packs 22 and 23 which engage into one another, wherein the plate pack 22 is fixed to the support unit 13 or to the second support unit part 15, and the plate pack 23 is fixed to the steering shaft bearing unit 1.

In the exemplary embodiment shown, the clamping bolt 20 extends through substantially vertically running slots 37 in the side cheeks 18 and through slots 33, running in a direction parallel to the longitudinal axis 3, in the support lugs 32 of the first casing part 4 of the steering shaft bearing unit 1. This can be seen particularly clearly in the partially sectional illustration, in the form of a vertical section, in FIG. 11. For the height adjustment, the steering shaft bearing unit 1 together with the steering shaft 2 and fixing device 38 or clamping bolt 20 is displaced in at least one vertical direction 29 along the slots 37 in the side cheeks 18. For the longitudinal adjustment in the longitudinal directions 28, the first casing part 4 is displaced relative to the clamping bolt 20 and relative to the support unit 13, and thus also relative to the side cheeks 18. Thereby a displacement of the throughslots 33 of the support lugs 32 of the first casing part 4 on to the clamping bolt 20 takes place.

In order that the steering shaft bearing unit 1 together with steering shaft 2 is prevented from falling downward when the locking device 38 is open, the preload springs 30 are provided, as is known per se from the prior art.

In the exemplary embodiment shown, the second casing part 5 is fixed by way of the flange 24 to the steering assistance unit 25. To realize the height adjustment in height directions 29, there is provided in this exemplary embodiment a pivot spindle 26 by means of which the steering assistance unit 25 can, together with the steering shaft bearing unit 1 attached thereto by way of the flange 24, be pivoted relative to the support unit 13.

For completeness, it is pointed out that this is self-evidently only one of several possible exemplary embodiments of a steering column 12 or steering shaft bearing unit 1 according to the invention. Steering columns 12 according to the invention may basically also be steering columns which are adjustable only in the longitudinal direction 28 or only in the height direction 29, or even non-adjustable steering columns. Steering columns according to the invention also need not imperatively have a steering assistance unit 25. In design variants without a steering assistance unit 25, in the case of a height-adjustable embodiment, it is also possible for the second casing part 5 to be fastened directly to a corresponding pivot spindle 26. In the case of non-height-adjustable steering columns 12, it is even possible for the second casing part 5 to be fixed to the vehicle body.

The construction of the exemplary embodiment according to the invention of a steering shaft bearing unit 1 of the steering column 12 shown here will be discussed below, in particular with reference to FIG. 9.

FIG. 9 is an exploded illustration clearly showing those parts of the steering shaft bearing unit 1 which are of relevance here. In this exemplary embodiment, the first casing part 4 is of two-part construction. Said first casing part has the first section 8, which in this case is in the form of a sheet-metal part which is at least regionally of trough-shaped form. Furthermore, the first casing part 4 also comprises the second section 9, which is formed in the manner of a sheet-metal cover part and which, as will be discussed further below, is fixed between the side walls 10 and 11 of the first section 8 during the course of the assembly or the production of the steering shaft bearing unit. Also situated on the first casing unit 4 are the support lugs 32 which have the abovementioned slot 33 through which the clamping bolt 20 extends for the purposes of fastening the steering shaft bearing unit 1 to the support unit 13. The second casing part 5 is in this case in the form of a casing tube to which the flange 24 is fastened or on which the flange 24 is integrally arranged.

In the exemplary embodiment shown, two slide bearings are provided which are arranged one behind the other in the direction of the longitudinal axis 3 and which are composed in each case of a slide bearing part 6 and of a slide bearing part 7. In the exemplary embodiment shown, the slide bearings are plain bearings. In the exemplary embodiment shown, the slide bearing parts 6 and 7 bear by way of their bearing surfaces 34 and 35 against the bearing surfaces 39 of the second casing part 5. In the embodiment shown, the slide bearing parts 6 and 7 are initially manufactured as individual parts which are of ring-shaped form in sections. These may be plastics or metal parts or even ceramic parts. In the embodiment shown, the slide bearing parts 7 are fixed in the first section 8 of the first casing part 4 by way of a screw connection or rivet connection or else by adhesive bonding or welding or the like. The slide bearing parts 6 are fixed by way of corresponding fastening measures to the second section 9, which forms the sheet-metal cover part, of the first casing part 4. It is pointed out that the individual slide bearing parts 6 and 7 which together form a slide bearing may also be realized in numerous other embodiments in terms of number, design and manner of fastening and arrangement. Accordingly, it is by all means conceivable for the corresponding slide bearing parts 6 and 7 to be formed directly integrally on the corresponding sections 8 and 9 of the first casing part 4. It is also conceivable for the slide bearing parts to be merely supported in the first casing part 4. Plastic, metal and ceramic are conceivable materials for the slide bearing parts 6 and 7. The shape of said slide bearing parts may differ from the embodiments illustrated here. Said slide bearing parts may be strip-shaped slide bearing parts, slide bearing parts which are of cylindrical form in sections, and the like. It is also not imperatively necessary for in each case two slide bearing parts 6 and 7, which together form a slide bearing, to be provided. In any case, the embodiment as simple plain bearings is expedient. Furthermore, as discussed in the introduction, the slide bearing parts are expediently substantially rigid bodies, that is to say are not springs, such as leaf springs or the like.

For completeness, it is also pointed out here that cross-sectional shapes other than those shown here in the exemplary embodiment may be implemented both in the case of the first and in the case of the second casing part 4, 5.

The method according to the invention for producing the steering shaft bearing unit 1 will be discussed once again below with reference to FIGS. 4 to 8.

In FIG. 5, the slide bearing parts 7 have already been fixed in the first section 8 of the first casing part 4. Then, in the first method step, the second casing part is inserted between the slide bearing parts 6 and 7, as illustrated in individual steps by FIGS. 4 to 7. Subsequently, in the second method step, the relative movement of the slide bearing parts 6 and 7 toward one another is performed, and thus the slide bearing parts 6 and 7 are pressed against the second casing part 5. Specifically, the bearing surfaces 34 and 35 of the slide bearing parts 6 and 7 are pressed against the bearing surfaces 39 of the second casing part 5. In the exemplary embodiment shown, said pressing action and the relative movement are realized by virtue of the slide bearing parts 6 together with the sheet-metal cover part in the form of the second section 9 being pushed from above, that is to say in the direction 40, against the second casing part 5, which has already been inserted into the lower slide bearing parts 7 and thus into the first section 8. In said second method step, it is expediently the case, as already discussed, that regulation of said pressing process or of said relative movement of the slide bearing parts 6 and 7 relative to one another is performed in a manner dependent on the displacement force and/or the distance covered during the relative movement of the slide bearing parts 6 and 7 toward one another, and/or in a manner dependent on the force with which the slide bearing parts 6 and 7, or at least one of the slide bearing parts 6 and 7, are or is pressed against the casing part 5. As discussed in the introduction, said regulation parameters may be used individually or in combination such that, ultimately, the slide bearing parts 6 and 7 with the second casing part 5 situated in between are moved toward one another, and pressed against the second casing part 5, to such an extent that the desired displacement force is realized. As discussed in the introduction, the displacement force is the force required to displace the casing parts 4 and 5 relative to one another in the direction of the longitudinal axis 3. When the displacement force lies in the desired value range, the slide bearing parts 6 and 7 are fixed in the first casing part 4 in the position attained by way of their relative movement in the third method step. In the exemplary embodiment shown here, this is realized by virtue of the second section 9 or the sheet-metal cover part being fixed in the first section 8 of the first casing part 4. Said fixing may, as discussed in the introduction, be realized by way of various welding methods known per se or else by screwing, riveting, wobbling, clinching and the like. In FIG. 10, in which only the first casing part 4 is illustrated, the fixing points 36 between the second section 9 and the first section 8 of the first casing part 4 are indicated.

By contrast to the variant shown in FIGS. 4 to 10, it may also be provided that, in the second method step, the slide bearing parts 6 are not attached to the section 9, and are pressed, without the latter, against the second casing part 5, and then in the third method step, are fixed for example to the side walls 10 and 11 of the first casing part 4. For this purpose, it is for example possible for corresponding recesses to be provided in the first casing part 4, through which recesses the slide bearing parts 6 can be displaced into the first casing part 4 for the purposes of the relative movement in the second method step and for the pressing action against the second casing part 5. For the guidance of the slide bearing parts 6, it is also possible for corresponding guides to be formed into the side walls 10 and 11 of the first casing part 4.

Regardless of which embodiment of the invention is realized, it is possible by means of the invention to realize defined displacement forces between the two casing parts 4 and 5, which permanently ensure play-free guidance of the second casing part 5 in the first casing part 4, and in particular also, in the event of a crash, prevent a situation in which uncalculated, unexpected forces act on the overall system as a result of the two casing parts 4 and 5 being displaced together. This ensures that, in the event of a crash, the absorption of energy, that is to say the dissipation of energy, in the steering column 12 is realized substantially exclusively by the correspondingly purposely designed energy absorption unit 17, and said absorption of energy is not disrupted by jamming of the two casing parts 4 and 5 one inside the other. In this way, while realizing low displacement forces, a high level of rigidity and a high natural frequency of the steering shaft bearing unit can be achieved. In particular, however, the method according to the invention and the steering shaft bearing unit 1 according to the invention are of such a simple construction that they can be realized inexpensively.

List of reference numerals:

| | |
|---|---|
| 1 | Steering shaft bearing unit |
| 2 | Steering shaft |
| 3 | Longitudinal axis |
| 4 | First casing part |
| 5 | Second casing part |
| 6 | Slide bearing part |
| 7 | Slide bearing part |
| 8 | First section |
| 9 | Second section |
| 10 | Side wall |
| 11 | Side wall |
| 12 | Steering column |
| 13 | Support unit |
| 14 | First support unit part |
| 15 | Second support unit part |
| 16 | Fastening lugs |
| 17 | Energy absorption unit |
| 18 | Side cheek |
| 19 | Adjustment lever |
| 20 | Clamping bolt |
| 21 | Cam-cam follower arrangement |
| 22 | Plate pack |
| 23 | Plate pack |
| 24 | Flange |
| 25 | Steering assistance unit |
| 26 | Pivot spindle |
| 27 | Steering wheel connection |
| 28 | Longitudinal direction |
| 29 | Height direction |
| 30 | Preload spring |
| 31 | Rotary bearing |
| 32 | Support lug |
| 33 | Slot |
| 34 | Bearing surface |
| 35 | Bearing surface |
| 36 | Fixing point |
| 37 | Slot |
| 38 | Locking device |
| 39 | Bearing surfaces |
| 40 | Direction |

1.-10. (canceled)

11. A steering shaft bearing unit configured to permit a steering shaft of a motor vehicle to be mounted there through such that the steering shaft is rotatable about a longitudinal axis, comprising:
a first casing part;
at least one slide bearing having at least a first slide bearing part and a second slide bearing part that are both fixedly disposed in said first casing part;
at least one second casing part disposed within said first casing part and guided between said first and second slide bearing parts, said second casing part being configured to be slidably displaceable along the longitudinal axis.

12. The steering shaft bearing unit of claim 11, wherein said second casing part is configured to be displaceable relative to said first casing part by an application of a displacement force of between 100 newtons and 600 newtons acting on said second casing part in a direction of said longitudinal axis.

13. The steering shaft bearing unit of claim 11, wherein said first casing part includes at least one first section having said first slide bearing part coupled thereto, and at least one second section having said second slide bearing part coupled thereto, and wherein said first and second sections of said first casing part are affixed to each other.

14. The steering shaft bearing unit of claim 13, wherein said first section of said first casing part is a trough-shaped channel made of sheet-metal and having at least a pair of sidewalls extending upwards therefrom, and wherein said second section of said first casing part is a sheet-metal cover affixed between said pair of side walls of said first section.

15. A steering column for a motor vehicle, comprising:
a steering shaft bearing unit of claim 11;
a steering shaft disposed through said first and second casing parts of said steering shaft bearing unit, so as to be mounted within said steering shaft bearing unit and rotatable about the longitudinal axis.

16. A method for producing a steering shaft bearing unit into which a steering shaft of a motor vehicle is to be mounted so as to be rotatable about a longitudinal axis, wherein the steering shaft bearing unit includes a first casing part, at least one slide bearing having at least a first slide bearing part and a second slide bearing part that are both fixedly disposed in the first casing part, and at least one second casing part disposed within the first casing part and guided between the first and second slide bearing parts, the second casing part being configured to be slidably displaceable along the longitudinal axis, the method comprising:
inserting the second casing part between the first and second slide bearing parts;
pressing the first and second slide bearing parts against the second casing part to a mated position by a relative movement of the first and second slide bearing parts toward one another; and
while in the mated position, affixing the first and second slide bearing parts within the first casing part.

17. The method of claim 16, further comprising, during said pressing step, determining a longitudinal displacement force that is require to displace the second casing part with respect to the first casing part along a direction of the longitudinal axis.

18. The method of claim 16, further comprising, during said pressing step, determining a distance over which the first and second slide bearing parts are moved with respect to each other.

19. The method of claim 16, further comprising, during said pressing step, determining a force with which at least one of the first and second slide bearing parts are pressed against the second casing part.

20. The method of claim 17, wherein said affixing step is performed in a position in which at least one of a displacement force, a travel distance, or a pressing force has reached one of a predefined value or is within a predefined value range.

21. The method of claim 16, wherein the first casing part includes at least one first section having the first slide bearing part coupled thereto, and at least one second section having said second slide bearing part coupled thereto, wherein during said affixing step, further affixing the first and second sections of the first casing part to each other so as to fix the slide bearing parts in the mated position.
